(19) United States
(12) Patent Application Publication
(10) Pub. No.: US 2020/0275802 A1
(43) Pub. Date: Sep. 3, 2020

(54) RESISTIVE CHARCOAL IGNITER SYSTEM AND METHOD

(71) Applicant: Charles Gary Grantham, Hidden Valley Lake, CA (US)

(72) Inventor: Charles Gary Grantham, Hidden Valley Lake, CA (US)

(21) Appl. No.: 16/879,660

(22) Filed: May 20, 2020

Related U.S. Application Data
(63) Continuation-in-part of application No. 16/274,221, filed on Feb. 12, 2019, now abandoned.
(60) Provisional application No. 62/742,219, filed on Oct. 5, 2018.

(51) Int. Cl. A47J 37/07; F23Q 7/02

(52) U.S. Cl. CPC A47J 37/079; F23Q 7/02

(57) ABSTRACT

Disclosed is a resistive charcoal igniter device for containing and igniting charcoal, lump charcoal, or charcoal briquets. The device has a cylindrical container with a wire base or grates in the bottom for containing the charcoal. An electrically operated heating element is located within the wire base. When charcoal is placed in the container, and the heating element is energized, the charcoal, lump charcoal, or charcoal briquets can be ignited after a sufficient time. The device also includes a handle affixed to the container and a heatshield placed between the handle and the container to protect a user's hand from heat generated within the container while holding the handle. The resistive heater is powered externally and may be electrically connected to a power source by an extension cord integrated into the device.

### CROSS-REFERENCE TO RELATED APPLICATION(S)

The present application is related to and claims priority to U.S. Non-Provisional patent application Ser. No. 16/274,221, filed Feb. 12, 2019, pending, which is related to and claims priority to U.S. Provisional Patent Application No. 62/742,219 filed Oct. 5, 2018, both of which are incorporated by reference in their entirety.

### BACKGROUND OF THE INVENTION

The following includes information that may be useful in understanding the present disclosure. It is not an admission that any of the information provided herein is prior art nor material to the presently described or claimed inventions, nor that any publication or document that is explicitly or implicitly referenced is prior art.

### TECHNICAL FIELD

The present invention generally relates to the field of barbeque cooking of existing art and, more specifically, relates to fuel lighters.

### RELATED ART

Cooking using a charcoal-fired barbecue is an effective and satisfying means of preparing a meal. Proponents of barbecue cooking often prefer the health advantages, taste preferences, or involved technique provided by cooking with a barbecue. However, many people avoid charcoal-fired barbecue cooking simply because they find it difficult, messy, or inconvenient. In particular, lighting the charcoal can present a dreaded chore for many. Charcoal, lump charcoal, or charcoal briquets can be difficult to light merely using a match or other light flame sources, and lighting the charcoal in the basin underneath the barbecue grill may also be messy. Flammable fluids may make lighting easier but can be hazardous and produce an unpleasant taste in the food prepared using those charcoal. The storage and safe use of flammables present a potential fire danger. These consumable materials must be purchased over and over, adding to barbecuing expenses. This difficulty in lighting charcoal, lump charcoal, or charcoal briquets may be one of the primary reasons that barbecuers often choose propane or electric cooking methods over charcoal cooking. A suitable solution is desired.

U.S. Pat. No. 5,197,455 to Ross Tessien relates to a charcoal starter. The described charcoal starter includes an improved charcoal starter that employs a grate having a conical shaped charcoal briquet receiving and stacking portion, to permit an enhanced rise of heat to impact the coals to get them to burn. The heat may come from paper kindling as conventionally disposed beneath the grate, or from a resistance heater element built into the grate. The grate may resemble a witch's hat with the retaining disk being the brim and a conical portion being disposed thereon, both with suitable apertures therein; or the grate can be made of suitable wire. The grate may be permanently mounted within the starter's cylindrical body or be removable.

### SUMMARY OF THE INVENTION

Because of the disadvantages inherent in the known charcoal ignition art, the present disclosure provides a novel resistive charcoal igniter system and method that is friendlier to the environment. The general purpose of this disclosure is to provide a resistive charcoal igniter system and method.

Disclosed is a resistive charcoal igniter device for containing and igniting charcoal, lump charcoal, or charcoal briquets. The device has a cylindrical container with a wire base or tray in the bottom for containing the charcoal. An electrically operated heating element is located within the wire base. When charcoal is placed in the container, and the heating element is energized, the charcoal, lump charcoal, or charcoal briquets ignites after enough time. The device also includes a handle affixed to the container and a heatshield placed between the handle and the container to protect a user's hand from heat generated within the container while holding the handle. The resistive heater is powered externally and may be electrically connected to a power source by an extension cord integrated into the device.

According to another embodiment, a method of igniting charcoal, lump charcoal, or charcoal briquets is also disclosed. The method of igniting charcoal, lump charcoal, or charcoal briquets includes providing the above-described device, inserting charcoal into the cylinder through the top end, depositing charcoal onto the grate, plugging the cord into a power source such as a wall outlet, heating the heating element, igniting the charcoal with the heating element, and dispensing the charcoal into a cooking device.

### BRIEF DESCRIPTION OF THE DRAWINGS

The figures which accompany the written portion of this specification illustrate embodiments and methods of use for the present disclosure, a resistive charcoal igniter system and method, constructed and operative according to the teachings of the present disclosure.

FIG. 1 is a perspective view of the device according to an embodiment of the disclosure.

FIG. 2 is a rear perspective view of the device of FIG. 1, according to an embodiment of the present disclosure.

FIG. 3 is a side perspective view of the device of FIG. 1, according to an embodiment of the present disclosure.

FIG. 4 is a top perspective view of the device of FIG. 1, according to an embodiment of the present disclosure.

FIG. 5 is a flow diagram illustrating a method of use for containing and igniting charcoal, lump charcoal, or charcoal briquets, according to an embodiment of the present disclosure.

### DETAILED DESCRIPTION

As discussed above, embodiments of the present disclosure relate to a fuel lighter and more particularly to a resistive charcoal igniter system and method as used to improve the lighting of charcoal, lump charcoal, or charcoal briquets for a barbecue.

The resistive charcoal igniter system includes a device for containing and igniting charcoal, lump charcoal, or charcoal briquets. The device includes a cylindrical container with a wire base in the bottom for containing the charcoal. The cylinder may be constructed of galvanized sheet steel and have apertures providing ventilation and airflow.

An electrically operated heating element is located within the wire base. When charcoal is placed in the container, and the heating element is energized, the charcoal, lump charcoal, or charcoal briquets ignite after enough time. The device also includes a handle affixed to the container and a heatshield placed between the handle and the container to protect a user's hand from heat generated within the container while holding the handle.

The resistive heater is powered externally and may be electrically connected to a power source by an extension cord integrated into the device. The resistive heating circuit can include an on-off switch. No fan or forced circulation means is necessary; instead, the device uses concentrated heat and passive ventilation to ignite the charcoal. Advantageously, the device incorporates a power supply providing options between four and six hundred watts to the heating element, thereby encouraging reliable ignition.

In use, a user may simply connect the device to a voltage source, place charcoal within the cylinder, activate the heating element, and wait for the charcoal to ignite. Thus, the device does not need constant monitoring to verify ignition success. Charcoal is a fuel in barbecue cooking.

The novel features of the invention are particularly pointed out in the specification. The present invention is described more fully by referencing the accompanying drawings and specification. The resistive charcoal igniter system may include a cylinder, a handle, a heatshield, an articulated auxiliary handle, a grate, a heating element, a power cord, and ventilation apertures.

The cylinder may be a thin hollow shell, preferably constructed of sheet metal. The handle may be coupled to the cylinder, providing a safe and rigid means of holding, lifting, and manipulating the cylinder. The ventilation apertures may be of sufficient size to permit adequate airflow through the cylinder and to encourage combustion within the cylinder. The articulated auxiliary handle may be a metal rod that is bent in a U-shape. The articulated auxiliary handle may attach to the heatshield using two hooks that are integral to the articulated auxiliary handle and may pass through apertures in the heatshield. The hooks may rotate within the apertures enabling the articulated auxiliary handle to move.

The power cord may act to electrically couple the heating element to a voltage source. Preferably, the power cord includes a 120-volt type power plug, such as a NEMA-1 or a NEMA-5 plug able to connect to a household wall outlet. Accordingly, the power cord may include internal conduits comprising power, neutral, and ground. The power cord may further include a voltage regulator, a power switch, a transformer, or any combination of these in various embodiments. The power cord may pass directing through an interior of the handle.

The handle itself may comprise plastic, metal, or a combination thereof. Preferably, the handle includes a sheet metal core having a first strut and a second strut, which rigidly coupled to the cylinder. In some versions, a plastic handle couple's the first strut and the second strut, or simply circumscribes the sheet metal core when the first strut and the second strut are integral to each other. The plastic handle may be sufficiently insulating to allow a user to comfortably grasp the handle even when combustion has been occurring within the cylinder for some time. The first and second struts may couple to the cylinder via screws, rivets, or other means. The first and second struts may take the shape of straight, flat bands with angled end pieces connecting to the cylinder.

The grate sits within the bottom of the cylinder. In some versions, the grate comprises one or more metal rods bent to form an air-permeable support. But in some versions, the grate spaces are small enough to impede charcoal passing through the grate. In this way, the grate may reliably support charcoal, while also enabling ample airflow through the grate, which encourages combustion within the cylinder. Because the grate in disposed within one end of the cylinder, the other end of the cylinder remains open, such that a user may deposit charcoal within the cylinder via the open end opposite the grate.

The heating element may mount to or be integral with the grate. In some versions, the grate includes three extensions mounted at one end to the cylinder and disposed proximally to the heating element. In some versions, these extensions regulate the proximity of the charcoal to the heating element. These three extensions may connect to two concentric rings, which provide strength and rigidity to the grate. The heating element may produce heat when energized by a voltage source. The heat may be sufficient to ignite charcoal in contact with or in proximity to the heating element. Preferably, the heating element has an output of approximately four to six hundred watts.

The heatshield may sit between the handle and the cylinder, and may rigidly mount to the handle, the cylinder, or both. The heatshield comprises a material having a low emissivity, such as sheet steel or aluminum, in some embodiments. The heatshield may help shield a user's hand from heat generated within the cylinder when the user is grasping the handle. The heatshield may be contoured around the cylinder to isolate heat away from the handle more effectively. Preferably, the cylinder is perforated, the perforations being the afore-mentioned ventilation apertures. The exact specifications, materials used, and method of use of the resistive charcoal igniter system may vary upon manufacturing.

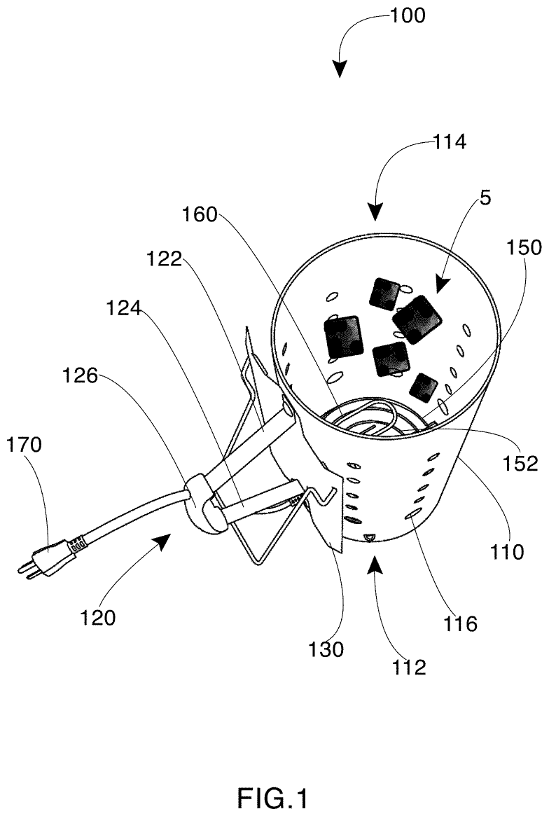

FIGS. 1-4 show various views of a device 100.

FIG. 1 shows a device according to an embodiment of the present disclosure. The device 100 may be useful for containing and igniting charcoal, lump charcoal, or charcoal briquets. The device may include cylinder 110, handle 120, heatshield 130, articulated auxiliary handle 140, grate 150, heating element 160, and power cord 170. Cylinder 110 may have bottom end 112 and top end 114. Bottom end 112 and top end 114 are opposite each other and represent circular apertures in the side of cylinder 110. The interior of cylinder 110 is substantially hollow. Grate 150 and heating element 160 sit inside cylinder 110. Handle 120 may rigidly couple to cylinder 110. Handle 120 may have first strut 122 affixed to cylinder 110 proximally to top end 114, and second strut 124 affixed to cylinder 110 proximally to the bottom end, and handle-grip 126 may bridge first strut 122 to second strut 124. In some embodiments, handle-grip 126 may comprise plastic, with first strut 122 and second strut 124 molded into handle-grip 126. Alternatively, first strut 122 may connect to or be integral with second strut 124, and handle-grip 126 may surround first strut 122 and second strut 124. In some versions, a single strut connects to the cylinder at an upper region and a lower region and passes through the handle. Handle 126 is split longitudinally with half of each part of handle 126 on either side of the strut. In some versions, handle 126 parts are on the front and back sides of the strut.

Yet further, handle-grip 126 may be constructed of alternate materials or affixed to first strut 122 and second strut 124 by other means. Heatshield 130 may rigidly couple to handle 120. In some versions, heatshield and handle 120 connect to cylinder 110 by fasteners which pass through apertures in cylinder 110, handle 120, and heatshield 130. Articulated auxiliary handle 140 may pivotably attached to heatshield 130 and may sit beneath handle 120, such that the combination of articulated auxiliary handle 140 and bottom end 112 of cylinder 110 can stably support device 100 on a surface. Grate 150 may be disposed interior to cylinder 110 and proximally to bottom end 112. Grate 150 may have a plurality of wire members 152 spaced sufficiently tightly to prevent the charcoal from passing out through bottom end 112 of cylinder 110. Grate 150 may be circular and may be concentric to cylinder 110. Heating element 160 may mount interior to cylinder 110. Heating element 160 may be close enough to grate 150 to heat and ignite charcoal when charcoal is resting upon grate 150. Power cord 170 able to selectively apply an electric current to heating element 160. “Selectively” may mean when a control system such as a switch activates heating element 160. Alternatively, “selectively” may merely mean when power cord 170 is plugged into a power source.

In some versions, heating element 160 is substantially flat and is not conical. This shape provides cylinder 110 with a larger volume useful for holding charcoal. In some versions, grate 150 is substantially flat and is not conical. This shape provides cylinder 110 with a larger volume useful for holding charcoal. In some versions, heating element 160 sits beneath grate 150. In some versions, grate 150 and heating element 160 are the same component. That is, heating element 160 is structured to impede charcoal from falling through heating element 160 into the region beneath heating element 160. In some versions, heating element 160 is above portions of grate 150 and below other portions of grate 150. In some versions, heating element 160 attaches to the top or bottom of grate 150. In some versions, heating element 160 is within 3, 2, 1, or ½ inches of grate 150. In some versions, grate 150 supports charcoal during ignition. That is, grate 150 is charcoal-supporting.

In some embodiments, cylinder 110 comprises galvanized sheet steel. Other highly reflective and radiant materials, such as aluminum or stainless steel, may be used alternatively. Heatshield 130 may sit between handle 120 and cylinder 110. And Heatshield 130 may comprise highly reflective metals. Highly reflective metals may include metals having an emissivity ratio under 0.2. Device 100 may also include a plurality of circular ventilation apertures 116 perforating cylinder 110. A plurality of circular ventilation apertures 116 may provide sufficient passive airflow in cylinder 110 to enable the combustion of charcoal within cylinder 110. Preferably, power cord 170 passes directly through an interior of handle 120, as illustrated.

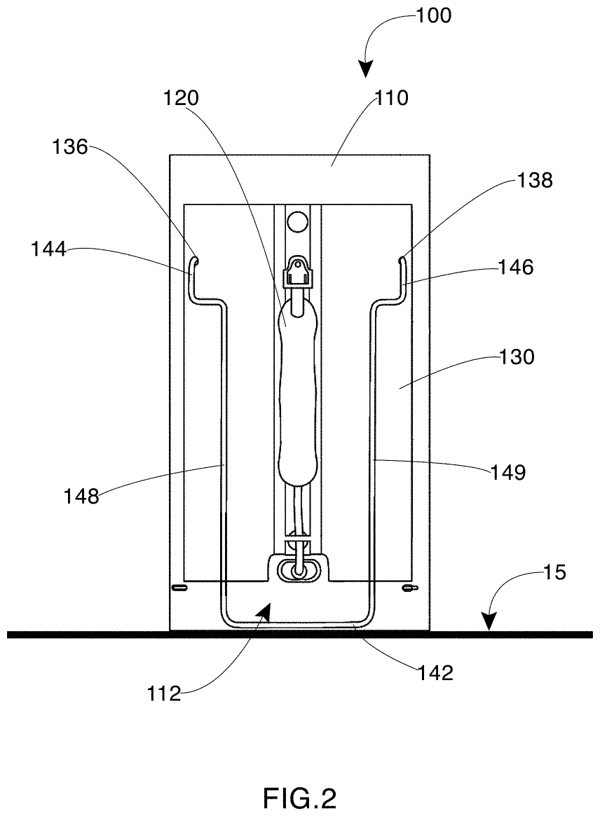

FIG. 2 shows device 100 of FIG. 1, according to an embodiment of the present disclosure. As shown, articulated auxiliary handle 140 may include straight base strut 142, first hook 144, second hook 146, first leg 148, and second leg 149. Straight base strut 142 may provide a secondary gripping location when articulated auxiliary handle 140 is deployed. First hook 144 may pivotably engage heatshield 130, and second hook 146 may likewise pivotably engage heatshield 130. First leg 148 and second leg 149 may each be perpendicularly arranged with straight base strut 142, forming a squared U-shape. Each of first hook 144 and second hook 146 may also be formed into a square U-shape as illustrated. This may be useful to prevent accidental removal of articulated auxiliary handle 140 from heatshield 130. First leg 148 may rigidly couple to first hook 144 to straight base strut 142, and second leg 149 may likewise rigidly couple second hook 146 to straight base strut 142. This may be done with each element at such an orientation that first hook 144 mirrors second hook 146 across handle 120, and first leg 148 mirrors second leg 149 across handle 120.

Heatshield 130 may also include first-aperture 136 and second-aperture 138 perforating heatshield 130. First-aperture 136 may be dimensioned and positioned to receive first hook 144 of articulated auxiliary handle 140, and second-aperture 138 may likewise be dimensioned and positioned to receive second hook 146 of articulated auxiliary handle 140. First-aperture 136 and second-aperture 138 may mirror each other over handle 120, with one disposed on a left side of heatshield 130, and the other on the right.

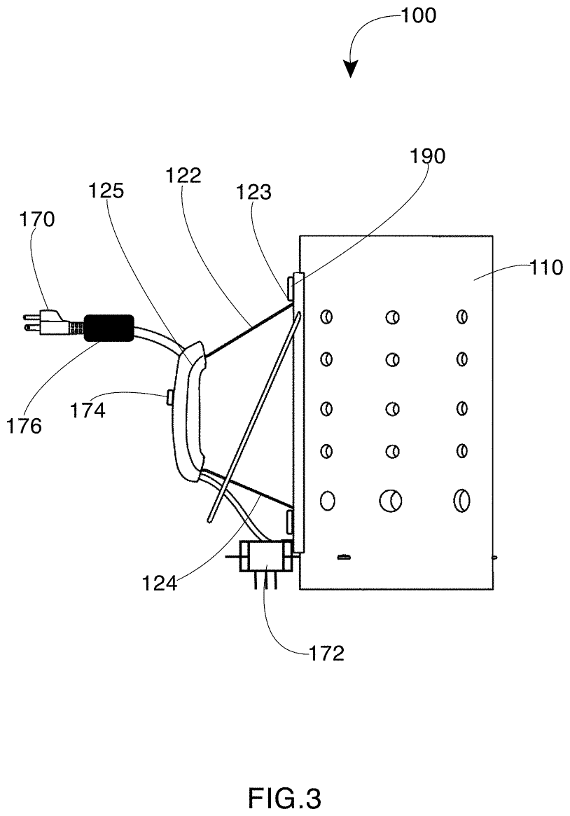

FIG. 3 may be a side perspective view of the device of FIG. 1, according to an embodiment of the present disclosure. First strut 122 and second strut 124 may each include, or be constructed of, a flat strip of metal, with each of the flat strips of metal having first-bend 123 and second-bend 125. Each of the first-bends 123 may be affixed to cylinder 110, and each of second-bends 125 may be affixed to handle-grip 126. Each of first strut 122 and second strut 124 may be fastened to cylinder 110 using fasteners 190, such that each of fasteners 190 passes through first-bend 123 of first strut 122 and first-bend 123 of the second strut. The same fasteners 190 may also pass through cylinder 110. Fasteners 190 may be bolts, screws, rivets, or other fasteners.

Power cord 170 may include a 120-volt type Nema-1 or Nema-5 power plug. This 120-volt type power plug may be able to removably couple to a household wall outlet and receive current thereby. In some versions, power cord 170 mounts at or through the top of handle 126 and is sometimes the male side of the plug. In some embodiments, power cord 170 may also include voltage regulator 172 configured to limit the voltage applied to heating element 160, power switch 174 able to turn heating element 160 on and off, and, in some versions, transformer is 176 able to convert an alternating current signal to a direct current signal. Device 100 may also include a power supply adapter to provide four hundred watts to heating element 160. Power supply adapter may be composed of one of the following, or a combination thereof: power cord 170, voltage regulator 172, power switch 174, and transformer 176. Various electric and electronic combinations or additions may be implemented. A system imparting four hundred watts to heating element 160 is an unexpectedly useful solution and is the preferred method. Various electric and electronic control or timer components may be added. The heating element may use up to 600 W in various configurations. For example, some embodiments do not require either voltage control or on/off switches.

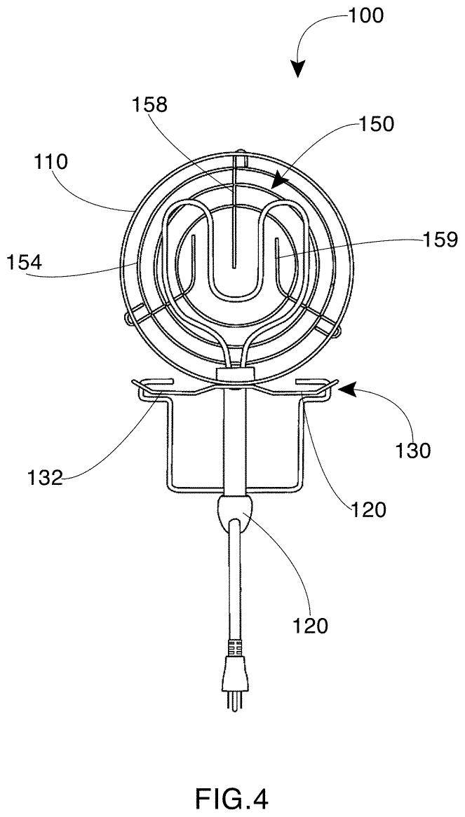

FIG. 4 may be a top perspective view of the device of FIG. 1, according to an embodiment of the present disclosure. Grate 150 may include at least two concentric wire rings 154 and at least one cross-member 156. At least one cross-member 156 may rigidly couple at least two concentric rings 154 to each other. At least one cross-member 156 may also rigidly couple at least two concentric rings 154 to cylinder 110. At least one cross-member may also include at least three extensions 158. Each of the three extensions 158 may rigidly couple at least two concentric rings 154 to cylinder 110, each of the three extensions 158 having bent terminus 159. Bent terminus 159 may space the charcoal from heating element 160. Bent terminus 159 may angle by approximately forty-five degrees from each of the extensions 158 in some embodiments. Heatshield 130 may also include first-corrugation 132 and second-corrugation 134, wherein each of first-corrugation 132 and second-corrugation 134 protrude laterally from either side of handle 120, respectively. And each of first-corrugation 132 and second-corrugation 134 have a concave side disposed toward cylinder 110. Heatshield 130 may help prevent heat produced within cylinder 110 from burning a user's handle when holding handle 120. Preferably, first-corrugation 132 mirrors second-corrugation 134 across handle 120.

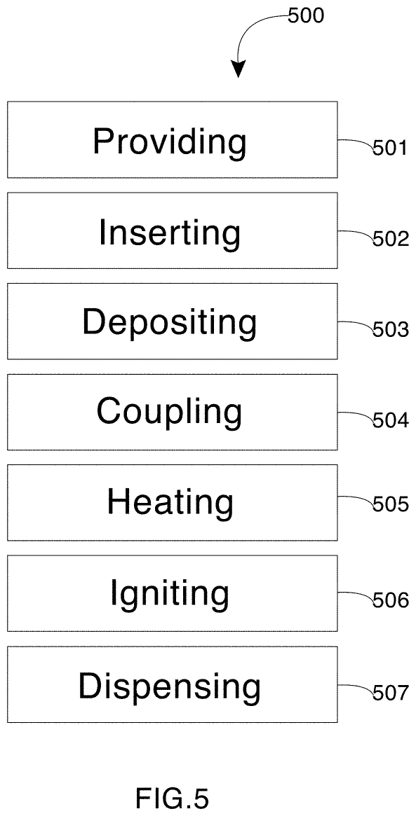

FIG. 5 is a flow diagram illustrating a method for lighting or igniting charcoal, lump charcoal, or charcoal briquets for a barbecue, according to an embodiment of the present disclosure. In particular, the method for lighting charcoal, lump charcoal, or charcoal briquets for a barbecue 500 may include one or more components or features of the device 100, as described above. As illustrated, the method for lighting charcoal, lump charcoal, or charcoal briquets for a barbecue 500 may include the steps of: step one 501, providing a device for containing and igniting charcoal, lump charcoal, or charcoal briquets, the device comprising a cylinder having a bottom end and a top end, a handle rigidly coupled to the cylinder, the handle having a first strut affixed to the cylinder proximally to the top end, and a second strut affixed to the cylinder proximally to the second end, and a handle-grip bridging the first strut to the second strut, a heatshield rigidly coupled to the handle, a grate disposed interior to the cylinder proximally to the bottom end, the grate having a plurality of wire members spaced sufficiently tightly to prevent charcoal from passing out through the bottom end of the cylinder, a heating element mounted interior to the cylinder, the heating element being sufficiently proximal to the grate to heat and ignite the charcoal when the charcoal is resting upon the grate, and a power cord able to selectively apply an electric current to the heating element; step two 502, inserting at least one of the charcoal into the cylinder through the top end; step three 503, depositing the at least one of the charcoal onto the grate; step four 504, coupling the power cord to a power source; step five 505, heating the heating element; step six 506, igniting the at least one of the charcoal in proximity to the heating element; and step seven 507, dispensing the charcoal into a cooking device.

It should be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for lighting charcoal, lump charcoal, or charcoal briquets for a barbecue, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A device for igniting charcoal, the device comprising:
a cylinder having a bottom end and a top end;
a handle rigidly coupled to the cylinder;
a tray disposed inside the cylinder having a plurality of wire members spaced to support charcoal;
a heating element mounted inside the cylinder close enough to heat and ignite the charcoal; and
a power cord connected to the heating element.

2. The device of claim 1, wherein the tray comprises at least two concentric wire rings and at least one cross-member rigidly coupling the at least two concentric rings to each other.

3. The device of claim 2, wherein the power cord directly connects to the heating element.

4. The device of claim 3, wherein the heating element produces 200-600, 300-500, or 400 watts.

5. The device of claim 4, wherein the power cord passes directly through an interior of the handle.

6. The device of claim 5, wherein the heating element is planar.

7. The device of claim 6, wherein the grate is planar.

8. The device of claim 7, wherein the heating element is placed above the grate.

9. The device of claim 8, wherein the heating element is within 3, 2, 1, or ½ inches of the grate.

10. The device of claim 9, wherein the grate is adapted to support charcoal.

11. The device of claim 10, wherein a heatshield is sandwiched between the handle and the cylinder.

12. The device of claim 11, wherein the heatshield further comprises a first corrugation and a second corrugation, each protruding laterally from the handle and wherein each of corrugation comprises a concave section disposed toward the cylinder.

13. The device of claim 12, wherein the power cord further comprises a 120-volt NEMA-1 or NEMA-5 plug.

14. The device of claim 7, wherein the heating element is placed beneath the grate.

15. The device of claim 14, wherein the heating element is within 3, 2, 1, or ½ inches of the grate.

16. The device of claim 15, wherein the grate is adapted to support charcoal.

17. The device of claim 7, wherein the heating element is placed beneath some portions of the grate and placed above other portions of the grate.

18. The device of claim 17, wherein the heating element is within 3, 2, 1, or ½ inches of the grate.

19. The device of claim 18, wherein the grate is adapted to support charcoal.

20. A method comprising the steps of:
providing the device of claim 1;
inserting charcoal into the cylinder through the top end;
depositing charcoal onto the tray;
powering the heating element;
igniting the charcoal with the heating element; and
dispensing the charcoal into a cooking device.
